(19) United States
(12) Patent Application Publication
(10) Pub. No.: US 2008/0026803 A1
(43) Pub. Date: Jan. 31, 2008

(54) Detachable Housings for a Wireless Communication Device

(75) Inventor: Randolph Cary Demuynck, Wake Forest, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/693,821

(22) Filed: Mar. 30, 2007

Related U.S. Application Data
(63) Continuation-in-part of application No. 11/460,711, filed on Jul. 28, 2006.

(51) Int. Cl. H04M 1/02

(52) U.S. Cl. 455/575.1

(57) ABSTRACT

A wireless communication device comprises a first housing detachably connected to a second housing in a first orientation and a second orientation. An electrical connector connects circuitry in the first and second housings regardless of whether the first and second housings are joined together in the first orientation or in the second orientation. A wireless interface connects the circuitry in the first and second housings when the first and second housings are separated.

### RELATED APPLICATIONS

This application is a continuation-in-part of co-pending U.S. application Ser. No. 11/460,711, filed Jul. 28, 2006, which is incorporated herein by reference in its entirety.

### BACKGROUND

The present invention relates generally to wireless communication devices, and particularly to portable clamshell wireless communication devices having releasably coupled housings.

Wireless communication devices such as cellular telephones have been in use for many years. One particularly popular design is commonly referred to as a “clamshell” cellular telephone. Clamshell type cellular telephones typically include two housing sections that are pivotably connected by a hinge mechanism. To place or receive a call using a clamshell cellular telephone, a user pivots the housings to an open position. When the user is finished, the user may terminate the call by pivoting the housings to a closed position. Other popular designs include a “jackknife” cellular telephone in which the user rotates two housings between open and closed positions, and a “slide” phone in which the user slides two housings relative to one another between a contracted position and an extended position.

Many consumers use their cellular telephones to perform functions in addition to the communication functions. For example, consumers may employ their cellular telephones to capture images and/or video, gain entry to restricted areas, or to facilitate purchases from suitably equipped vendors. The designs of conventional cellular telephones, however, may not be the most appropriate for all circumstances.

### SUMMARY

The present invention comprises a wireless communication device having first and second housing sections. The housing sections are detachably connected to each other such that the second housing section can be attached to the first housing section in either a first orientation or a second orientation. The housing sections may also movably connected to each other such that they move between a first position and a second position regardless of the orientation of the second housing. An electrical interface, such as an edge connector for example, operatively connects circuitry disposed in the first and second housing sections when the housing sections are joined together. A wireless interface, such as a short-range communication link for example, operatively connects the circuitry when the housing sections are separated.

In one embodiment, the circuitry within the first housing section includes radio frequency (RF) circuitry and an antenna that allows a user to transmit signals to and receive signals from a remote party via a base station subsystem (BSS) in a wireless communication network. The circuitry within the second housing includes baseband circuitry to process the transmitted/received signals. These interfaces allow the user to communicate with the remote party regardless of whether the housing sections are joined together, or separated. By way of example, the user could employ the device as a cellular telephone when the housing sections are connected. When separated, the user could attach the first housing section with the RF circuitry to their clothing. This would free the second housing section with the baseband circuitry to be placed in the user's pocket or purse, or carried around the user's neck using a lanyard.

The second housing section may be attached to the first housing section in either a first orientation or a second orientation. In the first orientation, a main display disposed within the second housing section faces towards the first housing section when the housing sections are in the second position. In the second orientation, the main display faces away from the first housing section when the first and second housing sections are in the second position. The first and second housing sections, however, remain pivotably attached regardless of the orientation of the second housing section.

### BRIEF DESCRIPTION OF THE DRAWINGS

FIG. 1 is a block diagram illustrating some components of a wireless communication device configured according to one embodiment of the present invention.

FIG. 2 is a perspective view illustrating a wireless communication device configured according to one embodiment of the present invention.

FIGS. 3A-3B are perspective views illustrating a clamshell-type wireless communication device having a housing in a first orientation according to one embodiment of the present invention.

FIGS. 4A-4B are perspective views illustrating a clamshell-type wireless communication device having a housing in a second orientation according to one embodiment of the present invention.

FIGS. 5A-5C are diagrams illustrating a possible configuration for electrically joining two housings of a wireless communication device according to one embodiment of the present invention.

FIG. 6 is a flow diagram illustrating how a controller might determine whether the two housings of the wireless communication device are joined or separated according to one embodiment of the present invention.

FIGS. 7A-7B are diagrams illustrating another configuration for electrically joining two housings of a wireless communication device according to one embodiment of the present invention.

FIGS. 8A-8B are perspective views illustrating a jackknife-type wireless communication device having a housing in a first orientation according to one embodiment of the present invention.

FIGS. 9A-9B are perspective views illustrating a jackknife-type wireless communication device having a housing in a second orientation according to one embodiment of the present invention.

FIGS. 10A-10B are perspective views illustrating a slider-type wireless communication device having a housing in a first orientation according to one embodiment of the present invention.

FIGS. 11A-11B are perspective views illustrating a slider-type wireless communication device having a housing in a second orientation according to one embodiment of the present invention.

### DETAILED DESCRIPTION

The present invention comprises a wireless communication device having first and second independent housing sections. The housing sections are configured to detachably connect to each other such that the housing sections may either be joined in a first or second orientation, or separated from each other. The housing sections may also pivotably connected such that, when joined, they move between a first position and a second position regardless of the orientation of the second housing section. A communication interface operatively connects circuitry in the first and second housing sections to allow the housing sections to function and communicate user data and signaling regardless of whether the housing sections are joined or separated.

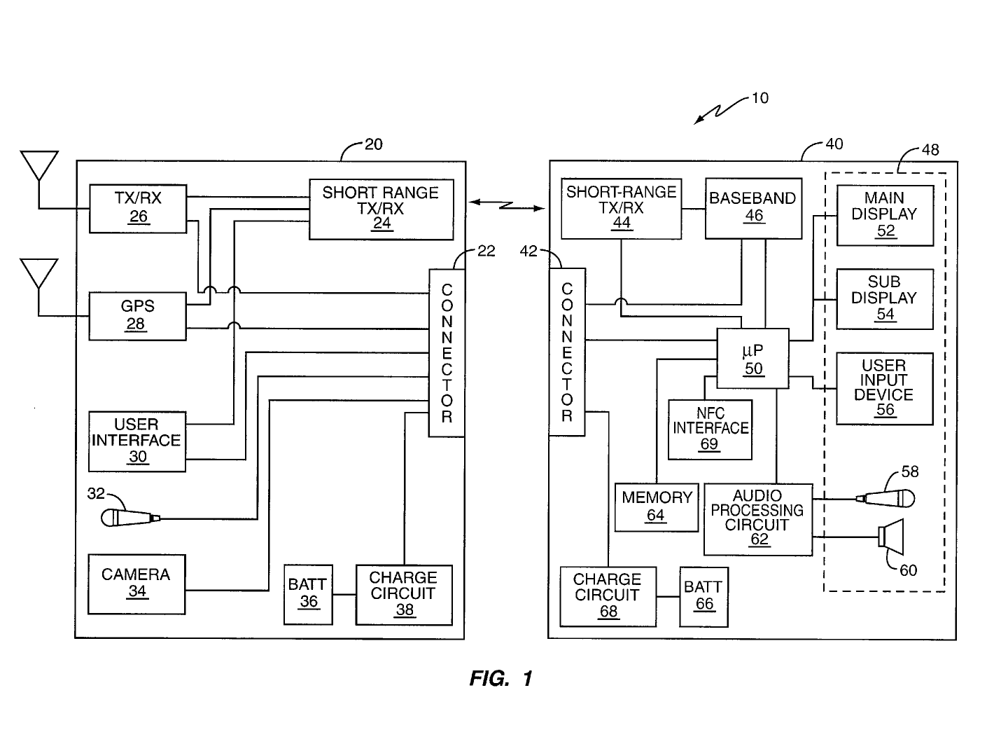

FIG. 1 illustrates the components of a wireless communication device 10 according to one embodiment. Those skilled in the art will appreciate that the components shown in FIG. 1 are illustrative and not limiting. Further, the figures illustrate device 10 as being a cellular telephone; however, the present invention is not so limited. Device 10 may also be a Personal Communication System (PCS) terminal, a Personal Digital Assistant (PDA) having communication capabilities, or other communication device having capable of transmitting and receiving signals to and from a wireless communication network.

Device 10 comprises a clamshell-type cellular telephone having a first housing section 20 and a second housing section 40. The first and second housing sections 20, 40 each have circuitry, and may be joined together or separated. Each housing section 20, 40 also includes an electrical connector 22, 42 and a short-range transceiver 24, 44. As described in more detail later, the electrical connectors 22, 42, which may be edge connectors, mate to form an electrical interface that operatively connects the circuitry when first and second housing sections 20, 40 are joined. The short-range transceivers 24, 44, which may be BLUETOOTH transceivers, form a wireless interface that operatively connects the circuitry when the first and second housing sections 20, 40 are separated.

As seen in FIG. 1, the first housing section circuitry includes, but is not limited to, a transceiver 26, a Global Positioning Satellite (GPS) receiver 28, a user interface 30, a microphone, 32, a camera 34 and a charging circuit 38 coupled to a power source, such as battery 36. Each of these components is well-known in the art; however, a brief description is included here for completeness.

Transceiver 26 and its corresponding antenna allow a user to wirelessly communicate speech and data signals to and from a Base Station Subsystem (BSS) in a wireless communications network. Transceiver 26 may be a fully functional cellular radio transceiver that operates according to any known standard including, but not limited to, the Global System for Mobile Communications (GSM), cdmaOne, cdma2000, UMTS, Wideband CDMA, WiFi, and WiMax. GPS receiver 28 and its antenna allow a user to receive information indicative of the current geographical location of the device 10. Typically, the GPS receiver 28 receives location data from one or more satellites (not shown) so that device 10 can process the received GPS signals to determine where the user is located geographically.

User interface 30 may include input devices such as a keypad, a touchpad, joystick control dials, control buttons, and other input devices, or a combination thereof. The user input interface 30 allows the user to dial numbers, enter commands, scroll through menus and menu items presented to the user on a display, and make selections. Microphone 32 receives and converts audible signals such as the user's speech into electrical audio signals. The user may capture images and/or video using camera 34, while battery 36 provides the first housing section 20 with power. A charging circuit 38 may operate to re-charge the battery 36 when the device 10 connects to a charging cradle or other external charging source.

The second housing section 40 circuitry includes the baseband circuitry 46, a user interface section 48, a controller 50, an audio processing circuit 62, memory 64, a battery 66 coupled to a charging circuit 68, and a Near Field Communication (NFC) interface 69. As above, the operation of these components is well known, and thus, only a brief description is included here for completeness.

The baseband circuitry 46 processes the signals transmitted and received by the transceiver 26. Generally, a received signal passes from transceiver 26 to the baseband circuitry 46 for channelization, demodulation, and decoding. For transmitted signals, the baseband circuitry 46 converts an analog signal, such as the user's voice detected at microphone 32 or microphone 60, into a digital signal and encodes the digital signal using the appropriate protocol for the network. The baseband circuitry 46 then performs channelization encoding and modulation as is known in the art, and sends the signal to transmitter 26 for transmission to the network.

The baseband circuitry 46 may perform its encoding/decoding functions using any method known in the art that is suitable for the network to which device 10 communicates. In one embodiment, for example, baseband circuitry 46 encodes/decodes voice data communicated over a circuit-switched connection using an appropriate protocol such as the Adaptive Multi-Rate (AMR) speech compression scheme. In another embodiment, baseband circuitry 46 encodes/decodes packetized voice data communicated over a packet-switched connection using an appropriate protocol such as the G.711 compression scheme. In some embodiments, device 10 is a dual-mode device, and thus, baseband circuitry 46 may perform encoding/decoding processing for both circuit-switched and packet-switched connections.

The user interface section 48 includes a main display 52, a sub-display 54, one or more user input devices 56 that the user can use to control device 10 when the housing sections 20, 40 are separated, a speaker 58, and another microphone 60. The main display and the sub-display 54 are disposed on opposing surfaces of the second housing section 40. As seen in more detail later, the user may dynamically configure the device 10 such that the second housing section 40 couples to the first housing section 20 in any of a plurality of orientations. Speaker 58 receives analog audio signals from audio processing circuit 62, and converts them into audible sound that the user can hear. Microphone 60, like microphone 30, converts audible sound, such as the user's speech, into electrical audio signals for processing by audio processing circuit 62.

Controller 50 controls the operation of wireless communications device 10 according to programs and/or data stored in memory 64. The control functions may be implemented in a single microprocessor, or in multiple microprocessors. Suitable processors may include, for example, both general purpose and special purpose microprocessors. The battery 66 provides the second housing section with power when the first and second housing sections 20, 40 are separated. One or both of the charging circuits 38, 68 may re-charge the battery 66 when the first and second housing sections are joined together.

NFC interface 69 may comprise a “tag” or chip that uses magnetic field induction to share user data and signaling with an external NFC device (not shown) over a short distance. The NFC interface 69 permits the user to employ device 10 as a “smartcard” or “keycard” to gain entry to a building or unlock door, or as a Point-of-Sale (PoS) device to purchase items from a merchant. The NFC interface 69 may be “active” (i.e., it includes it's own internal power supply) or “passive” (i.e., it does not include it's own internal power supply). In operation, the user simply “touches” device 10 to the external NFC device, such as an NFC reader, so that the NFC interface 69 is in close physical proximity to the NFC reader. This establishes an NFC communication link between the NFC interface 69 and the NFC reader over which the user data and signaling is communicated. A device connected to the NFC reader can then use this information to perform some function such as unlock a door or facilitate a purchase.

According to the present invention, controller 50 may execute logic to automatically detect whether the first and second housings 20, 40 are separated or joined. If joined, the controller 50 may automatically detect the orientation of the second housing section 40, and generate control signals to control the operation of the circuitry in one or both of the first and second housings 20, 40 based on the determinations. The ability to join or separate the housing sections 20, 40 allows the user to employ the functionality of device 10 in any of a plurality of different configurations.

For example, the transceivers in some conventional clamshell-type devices integrate the baseband-processing circuitry that processes the transmitted and received signals. Thus, the transceivers and the baseband processing circuits are typically co-located within a single housing section. One embodiment of the present invention, however, separates the transceiver 26 circuits and the baseband circuitry 46 such that they are disposed in different housing sections. This permits the user to use device 10 to communicate with remote parties regardless of whether the housing sections are joined together or separated.

Particularly, when the housing sections 20, 40 are separated, controller 50 may generate one or more control signals to cause the short-range transceiver 44 to establish a wireless communication link with the short-range transceiver 24. The link may be, for example, a BLUETOOTH link that facilitates relatively short-range communications between the housing sections 20, 40. Once established, the controller 50 may generate other signals to transceiver 26 and/or baseband circuit 46 to cause those two components to communicate user data and signaling via the established wireless interface.

For example, the first housing section 20 might be worn on the user's hip while the second housing section 40 may be placed in the user's shirt pocket. User data and signaling sent and received by transceiver 26 would be communicated to the circuitry in the second housing section 40 via short-range transceivers 24, 44. This would allow the user to use the second housing section 40 for various functions without requiring the device 10 to be in the joined configuration. For example, the user could place and receive calls, or control the camera 34, or use the second housing section 40 as a keycard or smartcard to gain access to a protected area using NFC interface 69.

When the housings sections 20, 40 are joined, the connectors 22, 42 mate to electrically connect the first and second housing section 20, 40 circuits. In this scenario, device 10 appears substantially as a conventional clamshell device. Thus, the controller 50 may generate control signals to “deactivate” or disable the established short-range communication link and instead, generate signals to cause the transceiver 26 and/or baseband circuit 46 to communicate the user data and signaling via the connectors 20, 40. Upon detecting that the user has once again separated the first and second housing sections 20, 40, the controller 50 could generate signals to “wake up” or re-activate the short-range communication link.

Similarly, the controller 50 may send and receive signals to control the GPS receiver 28, the user interface 30, microphone 32, and camera 34 via the connectors 22, 42 or the short-range transceivers 24, 44 based on whether the housing sections 20, 40 are joined or separated. In one embodiment, for example, the controller 50 determines the user's current location from location data received from the GPS receiver 28 via the connectors 22, 42 or the short-range transceivers 24, 44. That information could be used by controller 50 in any of a plurality of application programs that might need such data.

The controller 50 might also selectively enable/disable microphone 32 or microphone 60 based on the configuration to prevent undesirable feedback from being generated. Particularly, when the housing sections 20, 40 are joined, controller 50 could enable microphone 32 but disable microphone 60. This would allow the user to use microphone 32 when conversing with remote parties. When separated, controller 50 could enable microphone 60 but disable microphone 32. This would allow the user to use the second housing section 40 as a handset to carry on a conversation with remote parties.

Likewise, the controller 50 could generate control signals to control the camera 34 to capture images and/or video, and/or receive data representing the captured images from camera 34 for processing. When the housing sections 20, 40 are joined, those control signals could be sent via the electrical interface formed by connectors 22, 42. When separated, those control signals could be sent via the short-range interface formed by the short-range transceivers 24, 44.

Additionally, when the housing sections 20, 40 are joined, the battery 36 could provide power for the circuitry in both housing sections 20, 40. When the housing sections are separated, the battery 36 would provide power only for the first housing section 20. Power for the second housing section 40 would be provided by the battery 66. In one embodiment, battery 66 comprises a lightweight re-chargeable lithium-based battery. Charging circuit 38 and/or charging circuit 68 would re-charge the battery 66 whenever the housing sections 20, 40 are joined.

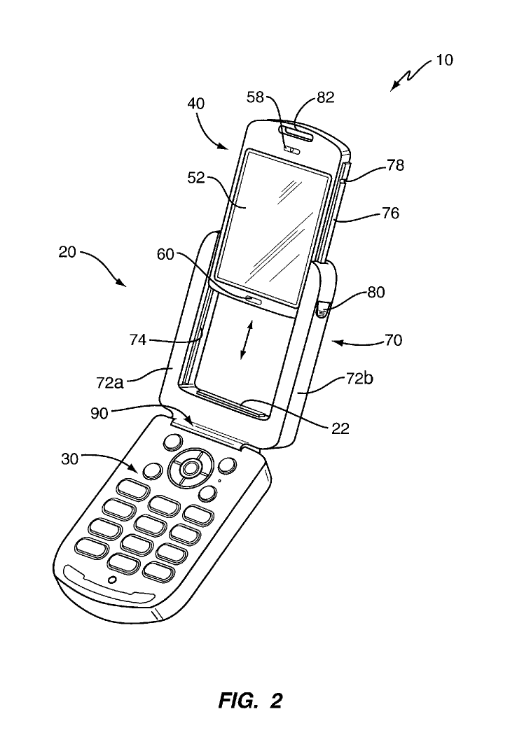

FIG. 2 illustrates a perspective view of how the second housing section 40 detachably connects to the first housing section 20 according to one embodiment. As seen in FIG. 2, the first housing section 20 comprises a “U-shaped” member 70 pivotably connected to the housing section 20 via a hinge mechanism 90. The hinge mechanism 90 may comprise a cartridge hinge, for example. However, other hinge mechanisms may be used to pivotably connect the first and second housing sections 20, 40. The hinge mechanism 90 allows a user to pivot the housing sections 20, 40 between a first position and a second position. In this embodiment, device 10 comprises a clamshell-type device, and thus, the hinge mechanism 90 facilitates movement between an open position and a closed position. However, as seen in more detail later, device 10 is not limited to being a clamshell design, and as such, other hinge mechanisms may be employed to facilitate movement between positions other than open and closed.

U-shaped member 70 includes a pair of opposing arms 72a, 72b, each including an integrally-formed a longitudinal slot 74 that extends substantially the length of the arm 72. Each slot 74 receives a corresponding rail 76 formed on the side of the first housing section 40. The slots 74 and the rails 76 guide the second housing section 40 such that connector 42, which is disposed on the second housing section 40, aligns with and connects to connector 22 on the first housing section 20. One or both of the rails 76 may also include a notch 78. The notch 78 mates with a locking mechanism formed on one or both of the arms 72. The locking mechanism, which may be spring-loaded, extends to mate with the notch 78 as the user slides the second housing section 40 between the arms 72. This helps to maintain the first and second housing sections 20, 40 joined together.

To separate the housing sections 20, 40, the user may depress one or more spring-loaded release buttons 80 integrally formed on the arms 72. When the release buttons 80 are depressed, the locking mechanism retracts from the notch 78 to allow the user to slide the second housing section 40 out of the U-shaped member 70. An opening 82 may be integrally formed on the second housing 40. The opening 82 could receive a lanyard (not shown) or other small cord to permit the user to secure the first housing section 20 around his or her neck, while suspending the first housing section 20 from a belt or other article of clothing.

As previously stated, the first and second housing sections 20, 40 may be movably attached such that the housing sections 20, 40 are movable between first and second positions in addition to being releasably connectable. The second housing section 40 may be releasably attached to the first housing section 20 such that it connects to the first housing section 20 in either a first orientation or a second orientation. According to the present invention, the orientation of the second housing section 40 does not affect the ability of the housing sections 20, 40 to move relative to one another.

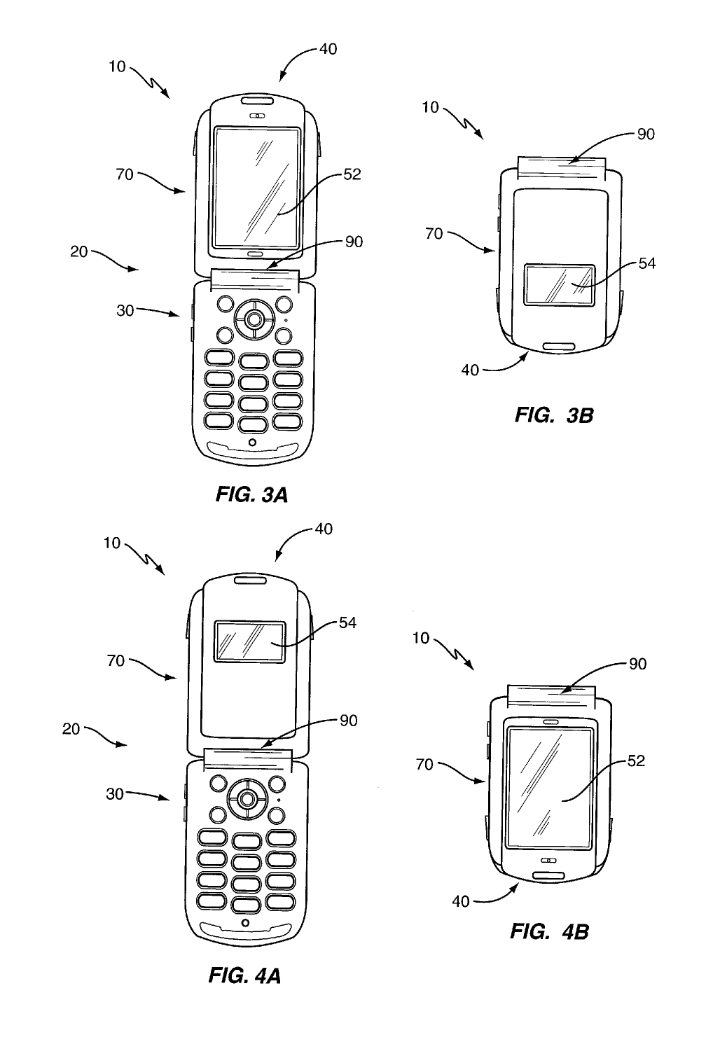

FIGS. 3A-3B are perspective views of a clamshell device, and illustrate the second housing section 40 as it might appear when connected to the first housing section 20 in a first orientation. Particularly, the second housing section 40 is inserted into the U-shaped member 70 as previously described. In this orientation, the main display 52 faces the user when the device 10 is in an open position (FIG. 3A), and is concealed when device 10 is in the closed position (FIG. 3B). In addition, the sub-display 54 faces toward the user when device 10 is in the closed position.

FIGS. 4A-4B are perspective views of the clamshell device, and illustrate the second housing section 40 as it might appear when connected to the first housing section 20 in a second orientation. In this orientation, the second housing section 40 is inserted into the U-shaped member 70 such that the sub-display 54 faces the user when the device 10 is in an open position (FIG. 4A), and is concealed when device 10 is in the closed position (FIG. 4B). Additionally, the main display 52 faces towards the user when device 10 is in the closed position.

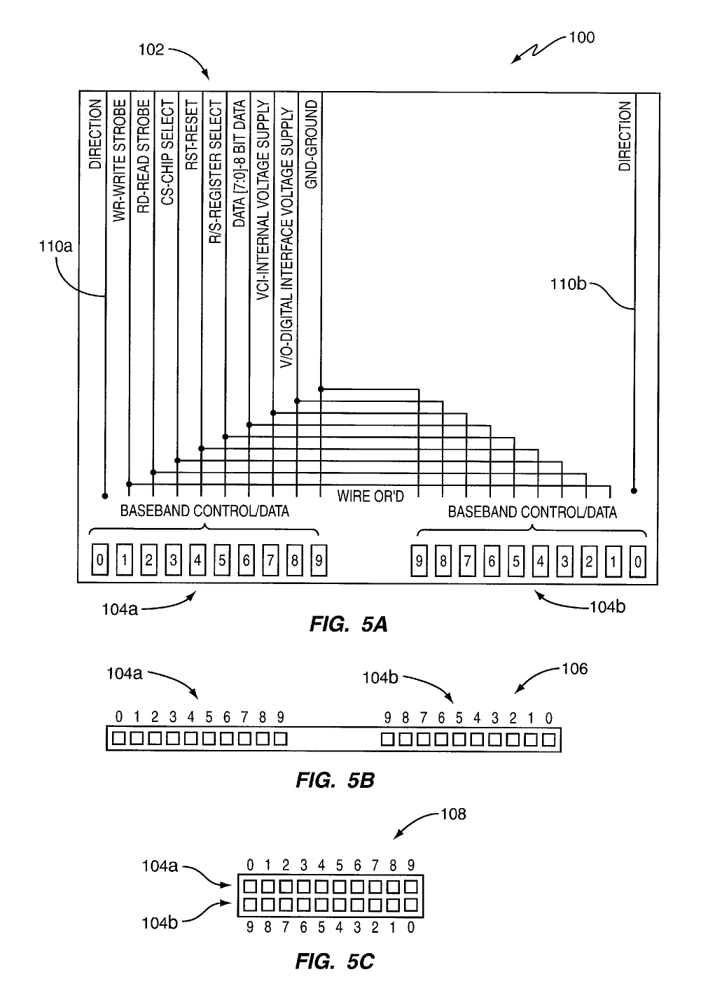

FIGS. 5A-5C illustrate how the connector 22 on the first housing section might be configured to allow the second housing section 40 to connect to it in either the first or the second orientations. Particularly, FIG. 5A is a wiring diagram 100 showing one or more wires 102. Each wire 102 carries specified baseband control data or other signals to a corresponding pin 104 in connector 22, and is cross-wired to provide that data to either a set of pins 104a or 104b. A pair of “direction” lines 110 carries a small voltage that, as described in more detail below, may be used by controller 50 to determine whether the first and second housing sections 20, 40 are joined or separated, and the orientation of the second housing 40. FIG. 5B illustrates a side-by-side configuration 106 for the connector pins 104, while FIG. 5C illustrates an alternate stacked configuration 108 for pins 104. The orientation of the second housing 40 will determine which pins 104a or 104b are used to connect the circuitry in the first and second housing sections 20, 40.

In a first orientation, pins 104a couple to the connector 42 on the first housing section 20. The pins 104b, however, would remain unconnected to connector 42. In a second orientation, pins 104b would connect to connector 24. The pins 104b would remain unconnected to connector 42.

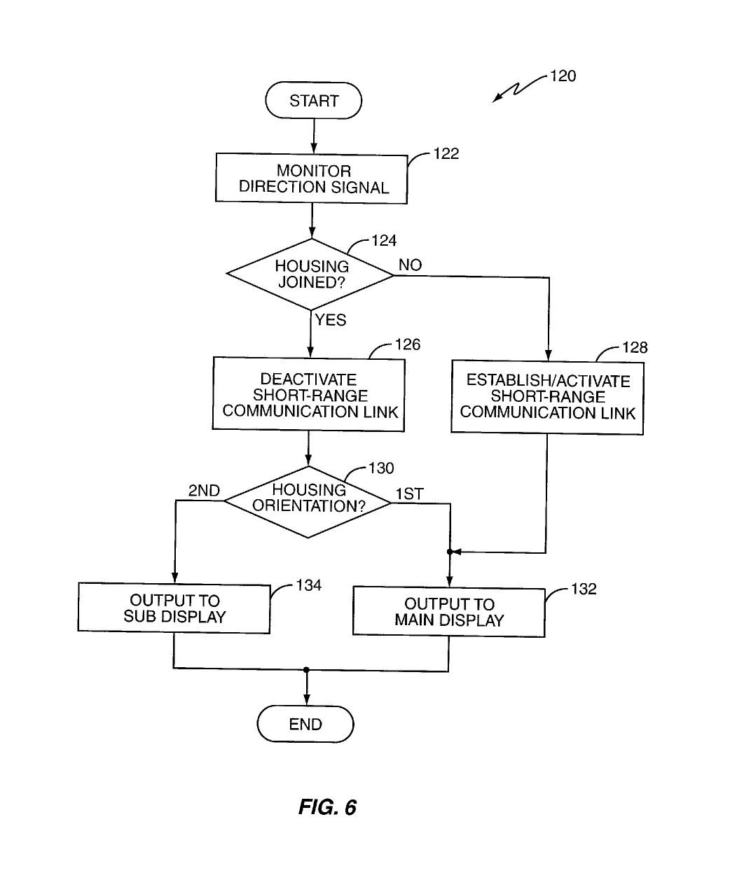

The controller 50 could determine from the electrical interface connection whether the housing sections 20, 40 are separated or joined. Further, if joined, the controller 50 could determine the orientation of the second housing 40. In one embodiment, shown in FIG. 6 for example, the controller 50 determines this information by monitoring the direction lines 110.

Method 120 begins with the controller 50 monitoring a detection signal (box 122). The detection signal could comprise the small voltage present on the direction line 110. If the controller 50 does not detect a voltage on one of the detection lines 110 (box 124), the controller 50 would determine that the housing sections 20, 40 are separated. Controller 50 could then establish or re-activate the short-range communication link established between the first and second housing sections 20, 40 (box 128), and output text and/or other media to the main display 52 (box 132). Otherwise, if the controller 50 detects a voltage on one of the detection lines 110, controller 50 would assume that the housing sections 20, 40 are joined (box 124). Controller 50 might then temporarily deactivate the short-range communication link (box 126) and determine whether the second housing is in the first or second orientation.

By way of example, the controller 50 could detect the voltage on direction line 110a, and thus, determine that the housing sections 20, 40 are in the first orientation (box 130). Alternatively, the controller 50 could detect the voltage on direction line 110b, and determine that the housing sections 20, 40 are in the second orientation (box 130). If the second housing section 40 is in the first orientation, controller 50 could output text and other appropriate data to the main display 52 and receive user input from the main display 52 (box 132). Otherwise, the second housing section is in the second orientation, and controller 50 could output text and other appropriate data to the sub-display 54 (box 134).

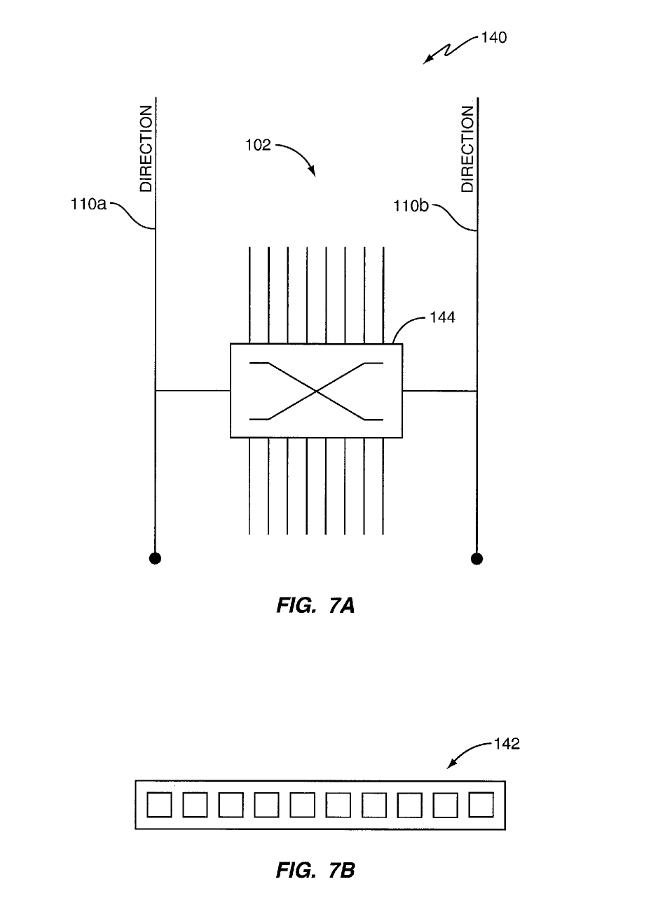

FIGS. 7A-7B illustrate another wiring diagram 140 and pin configuration used in another embodiment. In this embodiment, a switch 144 cross-connects the wires 102 to pins 142 based on whether a voltage is carried by direction line 110a or 110b. For example, if the voltage is carried by direction line 110a, the second housing section 40 is in the first orientation. The voltage on the direction line 110a causes switch 144 to cross-connect the wires 102 to pins 142 such that they are configured similarly to pins 104a. Conversely, if the voltage is carried by direction line 110b, the second housing section 40 is in the second orientation. The voltage on the direction line 110b causes switch 144 to cross-connect the wires 102 to pins 142 such that they are configured similarly to pins 104b.

The embodiment of FIG. 7 allows for smaller connectors 22, 42 and fewer pins. However, those skilled in the art will appreciate that the present invention does not need or require a direction line 110 to explicitly determine whether the housing sections 20, 40 are joined or separated, or to determine the orientation of the second housing section 40. In some embodiments, the data and signals on wires 102 are on all pins of connector 22 simultaneously. Thus, a user may connect the first and second housing section circuitry simply by plugging-in the second housing section 40 to the first housing section 20.

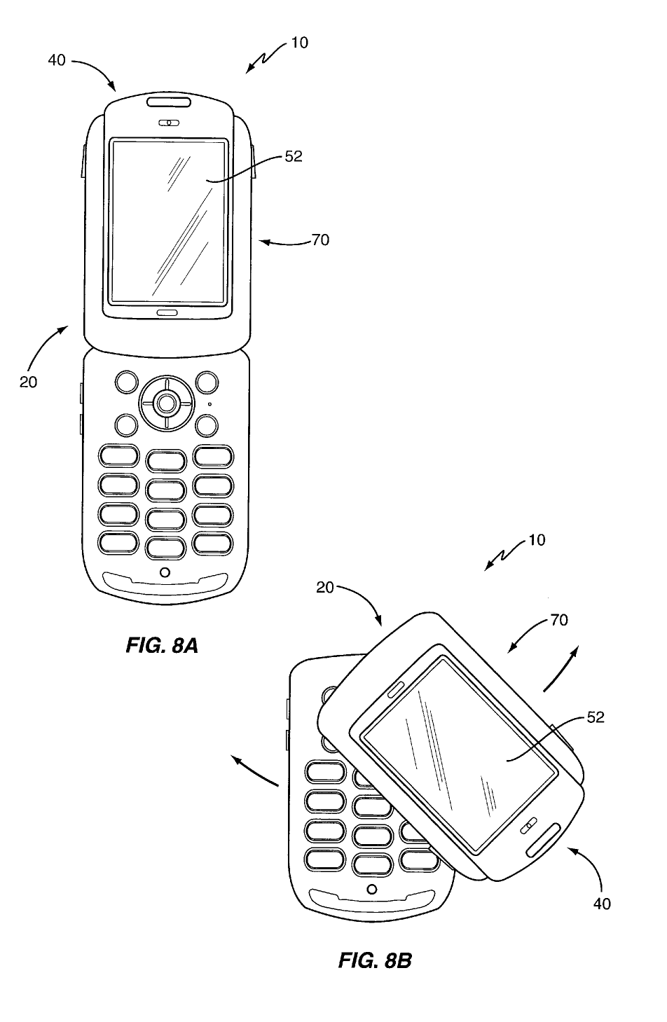

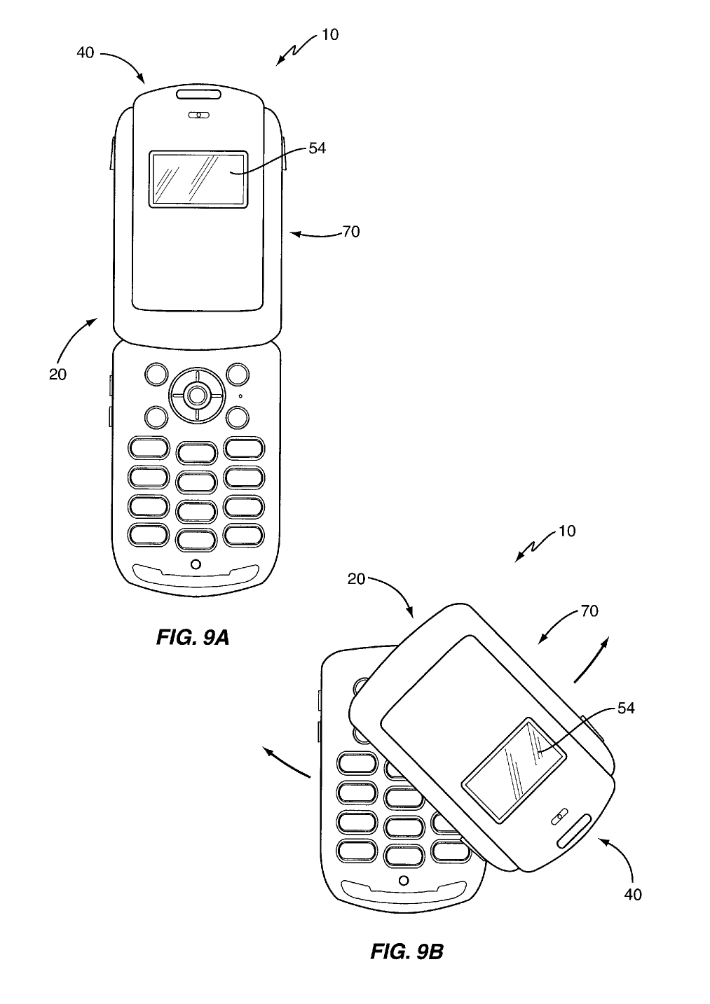

Although the previous embodiments have been described in the context of a clamshell-type cellular telephone, the present invention is not so limited. As seen in FIGS. 8A-8B and 9A-9B, for example, the present invention may be employed in a jackknife-type cellular device. FIGS. 8A-8B illustrate the second housing section 40 as it connects to the first housing section 20 in the first orientation, while FIGS. 9A-9B illustrate the second housing section 40 as it connects in the second orientation. In this embodiment, a hinge pivotably or rotatably connects the first and second housing sections 20, 40. The user moves the first and second housing sections 20, 40 between the first and second positions by pivoting the housing sections 20, 40 about the hinge.

To change the orientation of the second housing section 40, the user simply detaches the first and second housing sections 20, 40, re-orients the second housing section 20, and re-connects the re-oriented second housing section 40 to the first housing section 20. When joined, connectors 22, 42 mate to form the electrical connection that operatively connects the first housing section 20 to the circuitry in the second housing section 40, such as displays 52, 54. When separated, the short-range transceivers 24, 44 operatively connect the circuitry between the two housings such that the housings 20, 40 communicate the user data and signaling between the two housing sections 20, 40.

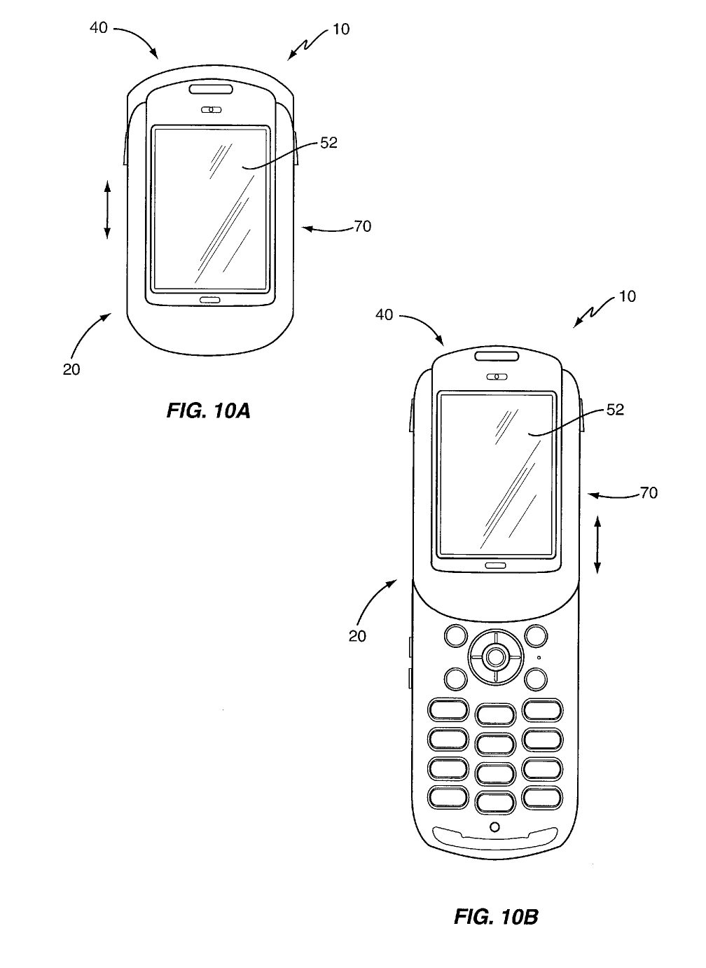

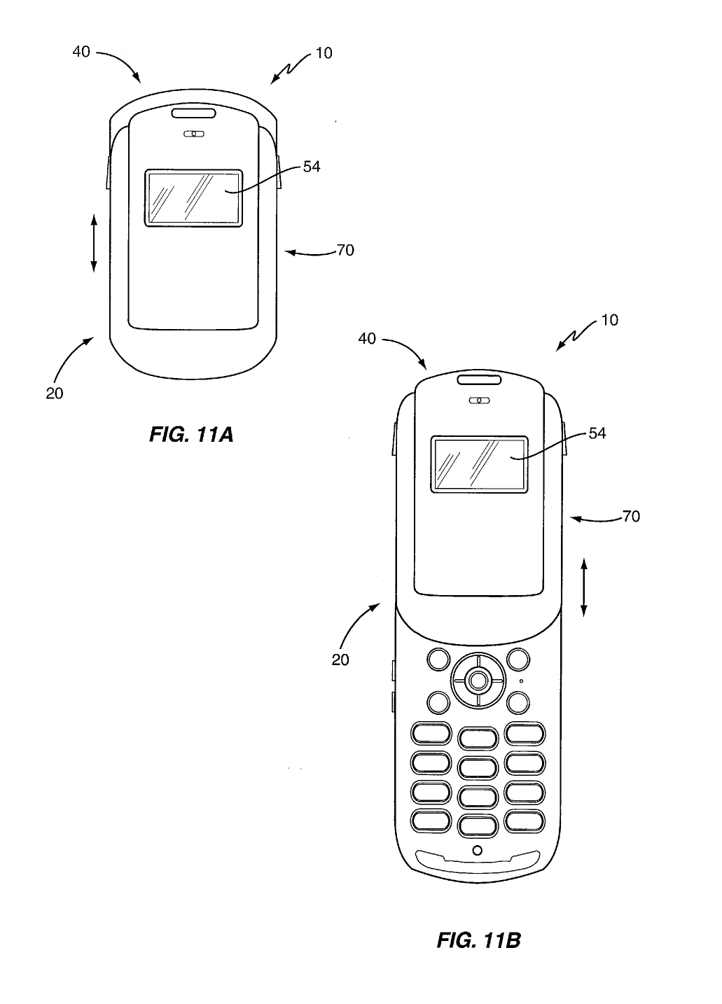

FIGS. 10-11 illustrate the present invention as used in a slider-type cellular device. As in the previous embodiments, the second housing section 40 may connect to the first housing section 20 in a first orientation (FIGS. 10A-10B), or a second orientation (FIGS. 11A-11B). However, the first and second housing sections 20, 40 are slidably connected rather than pivotably connected. Thus, the housing sections 20, 40 in this embodiment slidingly move between first and second positions regardless of the orientation of the second housing section 40.

Changing the orientation in slider phones may be accomplished as previously described. When joined, connectors 22, 42 mate to form the electrical connection that operatively connects the housing sections 20, 40 circuitry. When separated, the short-range transceivers 24, 44 communicate the user data and signaling between the two housing sections 20, 40.

The previous embodiments have described the housing sections 20, 40 as being movable between first and second positions. Those skilled in the art should appreciate that the first and second positions are not limited to being “open” or “closed” positions. Any of the devices 10 disclosed herein could be configured such that their housing sections 20, 40 move between positions other than open or closed. By way of example, some embodiments of device 10 may include housing sections 20, 40 that are movably connected to move to intermediate positions in addition to or in lieu of the open and closed positions.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless communication device comprising:
a first housing section detachably connected to a second housing section such that the second housing section can be connected to the first housing section in a first orientation and a second orientation;
the first and second housing sections being movable between first and second positions in both the first and second orientations;
an electrical interface configured to operatively connect circuits in the first and second housing sections when the first and second housing sections are joined together in both the first and second orientations; and
a wireless interface configured to operatively connect the circuits in the first and second housings sections when the first and second housing sections are separated.

2. The wireless communication device of claim 1 wherein the first housing section comprises radio frequency (RF) circuitry configured to transmit signals to and receive signals from a wireless communication network.

3. The wireless communication device of claim 2 wherein the second housing section comprises baseband circuitry configured to process the signals transmitted to and received from the wireless communication network.

4. The wireless communication device of claim 1 wherein the second housing section comprises a main display disposed on one side of the second housing section, and a sub-display disposed on an opposite side of the second housing section.

5. The wireless communication device of claim 1 wherein the electrical interface comprises a pair of corresponding connectors disposed on each of the first and second housing sections that couple when the first and second housing sections are joined together.

6. The wireless communication device of claim 5 wherein each of the first and second housing sections comprises a short-range transceiver and wherein the wireless interface comprises a short-range communication link established between the short-range transceivers.

7. The wireless communication device of claim 1 wherein the second housing section comprises a controller configured to determine whether the first and second housing sections are joined together.

8. The wireless communication device of claim 7 wherein the controller is configured to deactivate the wireless interface when the first and second housing sections are joined together, and activate the wireless interface when the first and second housing sections are separated.

9. The wireless communication device of claim 7 further comprising a microphone in each of the first and second housing sections, and wherein the controller is configured to:
activate the microphone in the first housing section when the first and second housing sections are joined together; and
activate the microphone in the second housing section when the first and second housing sections are separated.

10. The wireless communication device of claim 1 further comprising:
a power source in each of the first and second housing sections; and
a charging circuit in the first housing section configured to recharge the power source in the second housing section when the first and second housing sections are joined together.

11. The wireless communication device of claim 1 further comprising a coupling mechanism configured to couple the second housing to the first housing in the first and second orientations.

12. A method of communicating with a wireless communication device, the method comprising:
detachably connecting a first housing section to a second housing section such that the second housing section can be connected to the first housing section in first and second orientations;
movably connecting the first and second housing sections such that the first and second housing sections move between first and second positions in both the first and second orientations;
electrically connecting circuits in the first and second housing sections when the first and second housing sections are joined together in the first and second orientations; and
wirelessly connecting the circuits in the first and second housings sections when the first and second housing sections are separated.

13. The method of claim 12 further comprising transmitting signals to and receiving signals from a wireless communication network using radio frequency (RF) circuitry disposed in the first housing section.

14. The method of claim 13 further comprising processing the transmitted and received signals using baseband circuitry disposed in the second housing section.

15. The method of claim 12 wherein detachably connecting the first and second housing sections comprises releasably joining the first and second housing sections together in the first orientation such that a main display disposed on the second housing section faces towards a user of the wireless communication device.

16. The method of claim 15 wherein detachably connecting the first and second housing sections comprises releasably joining the first and second housing sections together in the second orientation such that the main display faces away from the user of the wireless communication device.

17. The method of claim 12 wherein electrically connecting circuits in the first and second housing sections comprises mating a connector on one of the first and second housing sections with a corresponding connector disposed on the other of the first and second housing sections.

18. The method of claim 17 wherein electrically connecting circuits in the first and second housing sections further comprises monitoring a signal to determine whether the first and second housing sections are joined together.

19. The method of claim 17 wherein electrically connecting circuits in the first and second housing sections further comprises deactivating the wireless interface when the first and second housing sections are joined together.

20. The method of claim 19 wherein wirelessly connecting the circuits in the first and second housings sections comprises activating a short-range communication link established between the first and second housing sections.

21. The method of claim 12 further comprising charging a battery disposed within the second housing section using a charging circuit disposed within the first housing section when the first and second housing sections are joined together.

22. A wireless communication device comprising:
a first housing section detachably connected to a second housing section;
a first display and a second display disposed on opposite sides of the second housing section;
one or more communication interfaces for operatively connecting the first and second displays to circuitry in the first housing section both when the first and second housing sections are joined, and when the first and second housing sections are separated.

23. The wireless communication device of claim 22 wherein the second housing section can connect to the first housing section in a first orientation and a second orientation.

24. The wireless communication device of claim 23 wherein each of the first and second housing sections comprise a connector that electrically connects the first and second displays to the first housing section when the first and second housing sections are joined in both the first and second orientations.

25. The wireless communication device of claim 24 wherein each of the first and second housing sections further comprise a short-range transceiver that wirelessly connects the first and second displays to the first housing section when the first and second housing sections are separated.

26. The wireless communication device of claim 23 wherein the first and housing sections are movably connected in both the first and second orientations.

27. A method of communicating using a wireless communication device, the method comprising:
detachably connecting a first housing section to a second housing section, the second housing section including a first display on one side and a second display on an opposite side;
operatively connecting the first and second displays to circuitry in the first housing both when the first and second housing sections are joined, and when the first and second housing sections are separated.

28. The method of claim 27 wherein detachably connecting a first housing section to a second housing section comprises detachably connecting the second housing section to the first housing section in a first orientation and a second orientation.

29. The method of claim 28 further comprising movably connecting the first and second housing sections such that the first and second housing sections move between first and second positions in both the first and second orientations.

30. The method of claim 28 wherein operatively connecting the second housing section to the first housing section comprises mating a connector disposed on the first housing section to a connector disposed on the second housing section.

31. The method of claim 30 wherein the connectors electrically connect the first and second housing sections in both the first and second orientations.

32. The method of claim 27 wherein operatively connecting the second housing section to the first housing section comprises wirelessly connecting the first and second housing sections via a short-range communication link when the first and second housing sections are separated.
